(19) United States
(12) Patent Application Publication
(10) Pub. No.: US 2025/0346469 A1
(43) Pub. Date: Nov. 13, 2025

(54) ADJUSTABLE OPERATION OF MANUFACTURING VEHICLES

(71) Applicant: Oshkosh Corporation, Oshkosh, WI (US)

(72) Inventor: Milan Klimes, Oshkosh, WI (US)

(73) Assignee: Oshkosh Corporation, Oshkosh, WI (US)

(21) Appl. No.: 19/086,571

(22) Filed: Mar. 21, 2025

Related U.S. Application Data
(60) Provisional application No. 63/643,528, filed on May 7, 2024.
(60) Provisional application No. 63/643,627, filed on May 7, 2024.
(60) Provisional application No. 63/643,788, filed on May 7, 2024.
(60) Provisional application No. 63/643,723, filed on May 7, 2024.
(60) Provisional application No. 63/643,608, filed on May 7, 2024.
(60) Provisional application No. 63/643,653, filed on May 7, 2024.
(60) Provisional application No. 63/643,617, filed on May 7, 2024.
(60) Provisional application No. 63/643,541, filed on May 7, 2024.
(60) Provisional application No. 63/643,631, filed on May 7, 2024.
(60) Provisional application No. 63/712,621, filed on Oct. 28, 2024.
(60) Provisional application No. 63/713,023, filed on Oct. 28, 2024.
(60) Provisional application No. 63/712,662, filed on Oct. 28, 2024.
(60) Provisional application No. 63/712,647, filed on Oct. 28, 2024.
(60) Provisional application No. 63/712,602, filed on Oct. 28, 2024.
(60) Provisional application No. 63/741,768, filed on Jan. 3, 2025.
(60) Provisional application No. 63/741,710, filed on Jan. 3, 2025.
(60) Provisional application No. 63/775,273, filed on Mar. 20, 2025.

(51) Int. Cl. B66F 9/06; B62D 65/18; B66F 9/075

(52) U.S. Cl. CPC B66F 9/063; B62D 65/18; B66F 9/0755

(57) ABSTRACT

A vehicle may include a frame, a drive system configured to propel the vehicle, an energy storage device configured to provide power to the drive system, a lift implement including a cradle to support a load and a lift assembly configured to adjust a position of the cradle relative to the frame, one or more sensors configured to provide sensing data indicative of at least one of a status of the vehicle, the load supported by the cradle, or an environment surrounding the vehicle, and a controller. The controller is configured to operate the vehicle in a first mode of a plurality of modes including a manual mode, a guided vehicle mode, and an autonomous mode, determine a match value between the sensing data and at least one operational criteria of a plurality of operational criteria; and operate the vehicle in a second mode based on the match value.

### CROSS-REFERENCE TO RELATED PATENT APPLICATIONS

This application claims the benefit of and priority to (a) U.S. Provisional Patent Application 63/643,653, filed on May 7, 2024, (b) U.S. Provisional Patent Application 63/643,631, filed on May 7, 2024, (c) U.S. Provisional Patent Application 63/643,541, filed on May 7, 2024, (d) U.S. Provisional Patent Application 63/643,627, filed on May 7, 2024, (e) U.S. Provisional Patent Application 63/643,723, filed on May 7, 2024, (f) U.S. Provisional Patent Application 63/643,528, filed on May 7, 2024, (g) U.S. Provisional Patent Application 63/643,788, filed on May 7, 2024, (h) U.S. Provisional Patent Application 63/643,617, filed on May 7, 2024, (i) U.S. Provisional Patent Application 63/643,608, filed on May 7, 2024, (j) U.S. Provisional Patent Application 63/712,602, filed on Oct. 28, 2024, (k) U.S. Provisional Patent Application 63/712,621, filed on Oct. 28, 2024, (1) U.S. Provisional Patent Application 63/713,023, filed on Oct. 28, 2024, (m) U.S. Provisional Patent Application 63/712,662, filed on Oct. 28, 2024, (n) U.S. Provisional Patent Application 63/712,647, filed on Oct. 28, 2024, (o) U.S. Provisional Patent Application 63/741,768, filed on Jan. 3, 2025, (p) U.S. Provisional Patent Application 63/741,710, filed on Jan. 3, 2025, and (q) U.S. Provisional Patent Application 63/775,273, filed on Mar. 20, 2025, each of which is incorporated herein by reference in its entirety.

### BACKGROUND

The present disclosure relates generally to vehicles. More specifically, the present disclosure relates to vehicles utilized to transport material.

In a manufacturing environment, products are moved along a manufacturing line as various assembly processes are performed. In some such embodiments, the products are supported and/or propelled by vehicles. These vehicles may have varying ways of supporting the products and may incorporate varying levels of autonomy.

### SUMMARY

In an exemplary embodiment, a vehicle includes a frame; a drive system coupled to the frame and configured to propel and steer the vehicle; an energy storage device coupled to the frame and configured to provide power to the drive system; a lift implement coupled to the frame, the lift implement including a cradle to support a load and a lift assembly configured to adjust a position of the cradle relative to the frame; one or more sensors configured to provide sensing data indicative of at least one of a status of the vehicle, the load supported by the cradle, or an environment surrounding the vehicle; and a controller comprising one or more memory devices having instructions stored thereon, that, when executed by one or more processors, cause the one or more processors to: operate the vehicle in a first mode of a plurality of modes, wherein the plurality of modes includes a manual mode, a guided vehicle mode, and an autonomous mode; determine a match value between the sensing data and at least one operational criteria of a plurality of operational criteria; and operate the vehicle in a second mode of the plurality of modes based on the match value, wherein the second mode is different than the first mode.

In another exemplary embodiment, a method of operating a vehicle includes operating, by one or more processing circuits, a vehicle in a first mode of a plurality of modes, wherein the plurality of modes includes a manual mode, a guided vehicle mode, and an autonomous mode; receiving sensor data indicative of one or more operational conditions; determining, by the one or more processing circuits, a match value between the one or more operational conditions indicated by the sensor data and one or more operational criteria, wherein the one or more operational criteria correspond to a mode of the plurality of modes and one or more operational conditions; and switching, by the one or more processing circuits, operation of the vehicle from the first mode to a second mode of the plurality of modes different than the first mode based on the match value indicating a match between one or more operational criteria and the one or more operational conditions indicated by the sensor data.

In another exemplary embodiment, a method of operating a vehicle, including: operating, by the one or more processing circuits, a vehicle in a first mode of a plurality of modes, wherein the plurality of modes includes a manual mode, a guided vehicle mode, and an autonomous mode, the vehicle including: a frame; a drive system coupled to the frame and configured to propel and steer the vehicle; an energy storage device coupled to the frame and configured to provide power to the drive system; a lift implement coupled to the frame, the lift implement including a cradle to support a load and a lift assembly configured to adjust a position of the cradle relative to the frame; and one or more sensors configured to provide sensing data indicative of at least one of a status of the vehicle, the load supported by the cradle, or an environment surrounding the vehicle; receiving, by the one or more processing circuits, sensor data from the one or more sensors indicative of one or more operational conditions; determining, by the one or more processing circuits, a match value between the one or more operational conditions indicated by the sensor data and one or more operational criteria, wherein the one or more operational criteria correspond to a mode of the plurality of modes and one or more operational conditions; and switching, by the one or more processing circuits, operation of the vehicle from the first mode to a second mode of the plurality of modes different than the first mode based on the match value indicating a match between one or more operational criteria and the one or more operational conditions indicated by the sensor data.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a vehicle according to an exemplary embodiment.

FIG. 2 is a top view of the vehicle of FIG. 1.

FIG. 3 is a perspective view of the vehicle of FIG. 1 equipped with a lifting implement, according to an exemplary embodiment.

FIG. 4 is a perspective view of the vehicle of FIG. 3 and another vehicle cooperating to support a telehandler, according to an exemplary embodiment.

FIG. 5 is a perspective view of the vehicle of FIG. 1 equipped with a cart implement, according to an exemplary embodiment.

FIG. 6 is a perspective view of the vehicle of FIG. 3 interfacing with a cart supporting a boom assembly, according to an exemplary embodiment.

FIG. 7 is a block diagram of a control system for the vehicle of FIG. 1.

FIG. 8 is a top view of a production system including the vehicle of FIG. 1, according to an exemplary embodiment.

FIG. 9 is a flow chart of a method for adjusting the operation of a vehicle, according to an exemplary embodiment.

### DETAILED DESCRIPTION

Before turning to the FIGURES, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, one or more vehicles may be configured to operate in one of a plurality of different modes of operation, including different degrees of autonomous operation (e.g., manually controlled, partially autonomous, or fully autonomous). In some embodiments, a vehicle can be configured to switch between different modes of operation (e.g., between a mode of operation that is substantially user controlled to a mode of operation that is fully, or at least substantially, autonomous). Stated differently, in some embodiments, the vehicles may be configured to switch between different levels of autonomous operation (e.g., minimally autonomous to fully autonomous and vice versa) based a user input or information related to the operation of the one or more vehicles, including based on the feasibility of operating a vehicle autonomously in the presence of one or more different operational conditions (e.g., inclement weather, power outage, steep grades, spills, unexpected obstacles, etc.). For example, the vehicles may switch between a first mode of operation and a second mode of operation based on a match value determined from sensor data, which is indicative of one or more operational conditions and one or more operational criteria.

### Overall Vehicle

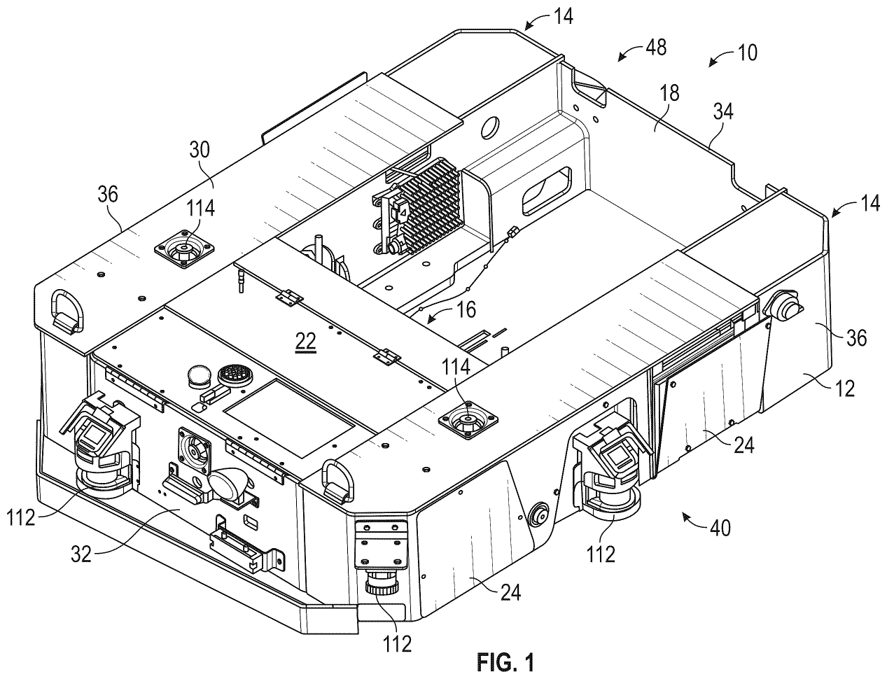

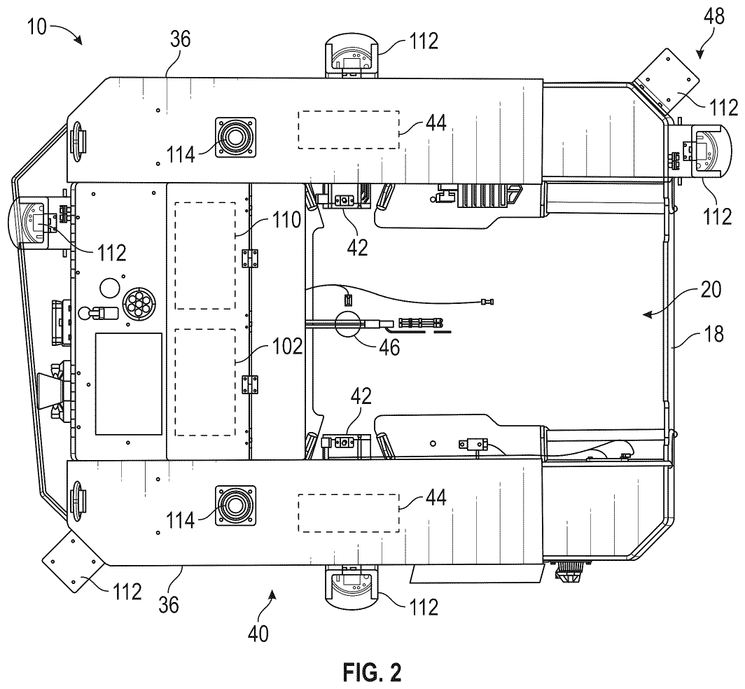

Referring to FIGS. 1 and 2, a machine, vehicle, trolley, transport, hauler, mule, or tug, is shown as vehicle 10 according to an exemplary embodiment. The vehicle 10 may be configured to support, push, pull, turn, or otherwise facilitate movement of a product or components of a product throughout a manufacturing environment. By way of example, the vehicle 10 may move a product (e.g., another vehicle or machine) along a manufacturing line as the product is assembled. The vehicle 10 may move the product between stations where different assembly operations are performed. Additionally or alternatively, the vehicle 10 may be used to move parts or subassemblies (e.g., booms, engines, tires, etc.) throughout the manufacturing environment (e.g., to the product, to a storage area, etc.).

The vehicle 10 may be manually controlled, partially autonomous, or fully autonomous. In some embodiments, the vehicle 10 is configured as a semi-automated guided vehicle (SGV). When configured as an SGV, the vehicle 10 may be manually operated by an operator (e.g., through a wireless or tethered user interface). By way of example, the operator may manually control the steering of the vehicle 10. In some embodiments, the vehicle 10 is configured as an automated guided vehicle (AGV). When configured as an AGV, the vehicle 10 may navigate along a predefined route (e.g., using a magnetic strip or other fixed navigation element). If the vehicle 10 configured as an AGV encounters an obstacle, the vehicle 10 may rely on manual intervention from an operator (e.g., through a user interface) to correct course and navigate around the obstacle. In some embodiments, the vehicle 10 is configured as an autonomous mobile robot (AMR). When configured as an AMR, the vehicle 10 may autonomously navigate through an area without requiring a predefined path. The vehicle 10 configured as an AMR may avoid obstacles without manual intervention by an operator.

The vehicle 10 includes a chassis, shown as frame 12, that supports the other components of the vehicle 10. In some embodiments, the frame 12 defines an enclosure that contains one or more components of the vehicle 10. The frame 12 includes a pair of side portions, shown as drive modules 14, a central portion, shown as controls enclosure 16, and a lateral member, shown as back plate 18. The drive modules 14 each extend longitudinally along the vehicle 10 and are laterally offset from one another. The controls enclosure 16 and the back plate 18 each extend laterally between the drive modules 14, fixedly coupling the drive modules 14 to one another. The controls enclosure 16 and the back plate 18 are longitudinally offset from one another, such that a recess or passage, shown as implement recess 20, is defined between the controls enclosure 16, the back plate 18, and the drive modules 14.

The drive modules 14 may contain components that facilitate propulsion of the vehicle (e.g., the drivetrain 40). The drive modules 14 may include one or more removable or repositionable panels, shown as drive module doors 24, that facilitate access to components within the drive modules 14 from outside of the vehicle 10. The controls enclosure 16 may contain components that facilitate powering or control over the vehicle (e.g., the controller 102, the batteries 110). The controls enclosure 16 includes a removable or repositionable panel, shown as controls enclosure door 22, that facilitates access to components within the controls enclosure 16 from outside of the vehicle 10. In other embodiments, the vehicle 10 includes a separate housing, body, or enclosure that is coupled to the frame 12 and contains one or more components of the vehicle.

The frame 12 defines a top surface 30, a front surface 32, a rear surface 34, and a pair of side surfaces 36 of the vehicle 10. The top surface 30 extends substantially horizontally across the drive modules 14 and the controls enclosure 16. A distance from the top surface 30 to the ground beneath the vehicle 10 may define a height of the vehicle 10. The front surface 32 is positioned at a front end portion of the frame 12 and extends substantially vertically and laterally across the drive modules 14 and the controls enclosure 16. The rear surface 34 is positioned at a rear end portion of the frame 12 and extends substantially vertically and laterally across the drive modules 14 and the back plate 18. The side surfaces 36 each extend longitudinally along one of the drive modules 14, between the front surface 32 and the rear surface 34.

The vehicle 10 includes a drive system or driveline, shown as drivetrain 40, that is configured to propel and steer the vehicle 10. The driveline includes a pair of actuators or motors (e.g., hydraulic motors, pneumatic motors, electric motors, etc.), shown as drive motors 42. In some embodiments, the drive motors 42 are electric motors powered by an electrical energy source (e.g., the batteries 110, energy from a power grid external to the vehicle 10, etc.). The drive motors 42 are each configured to provide rotational mechanical energy to drive rotation of one or more tractive elements 44 (e.g., wheel and tire assemblies, shown in FIG. 2). In some embodiments, the drive motors 42 drive the left and right sides of the drivetrain 40 independently, facilitating skid steer operation of the vehicle 10. By way of example, the tractive elements 44 may be driven at the same speed and in the same direction to travel straight. By way of another example, the tractive elements 44 may be driven at different directions and/or at different speeds to turn the vehicle 10. By driving the tractive elements 44 at the same speed and in opposite directions, the drivetrain 40 may rotate the vehicle 10 about a substantially vertical axis, shown as central axis 46, that is substantially centered relative to the frame 12. Rotation of the vehicle 10 about the central axis 46 may facilitate reorienting the vehicle 10 without changing position (i.e., turning in place).

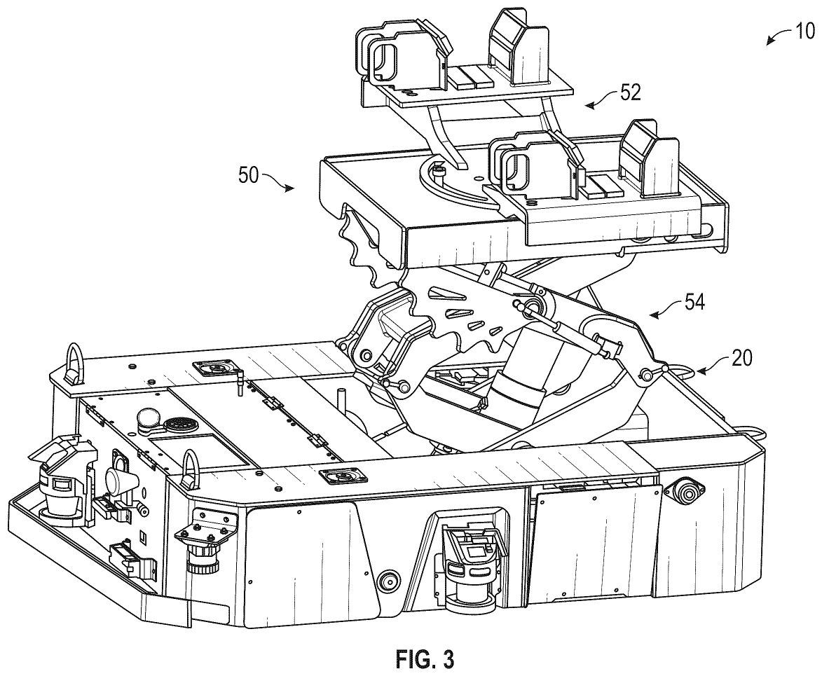

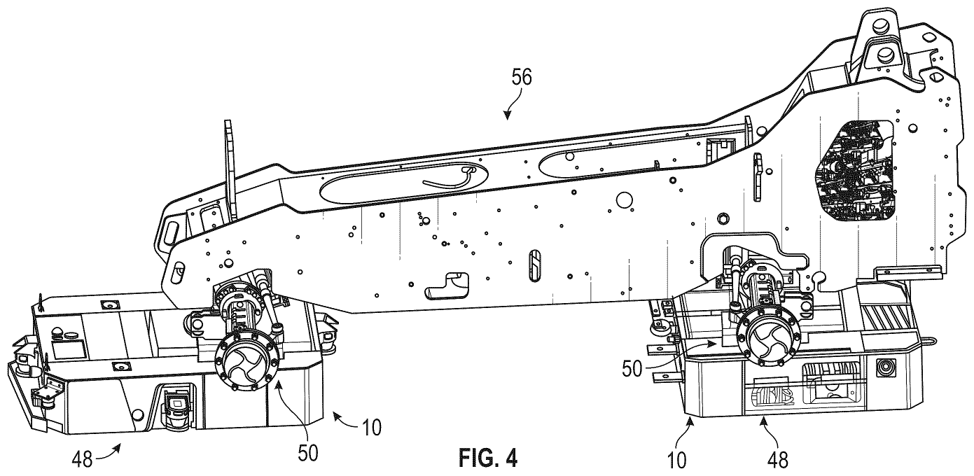

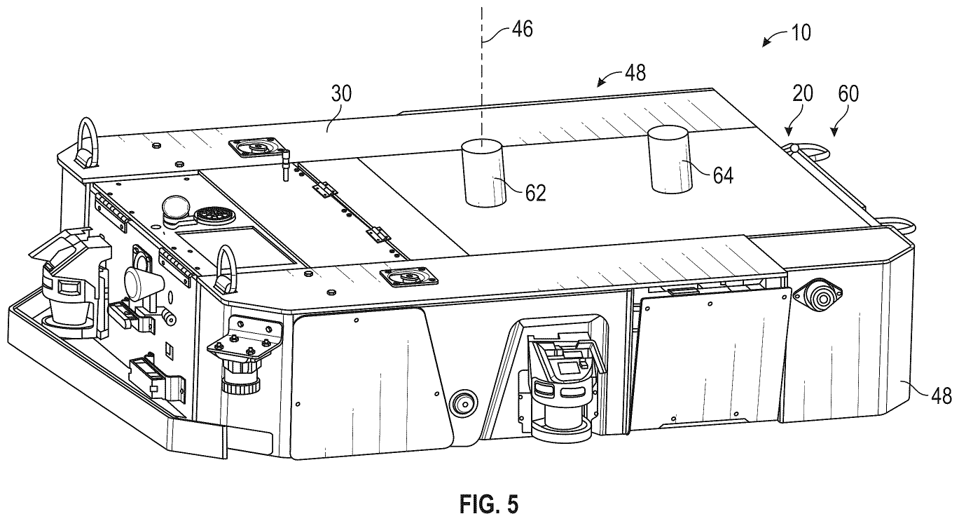

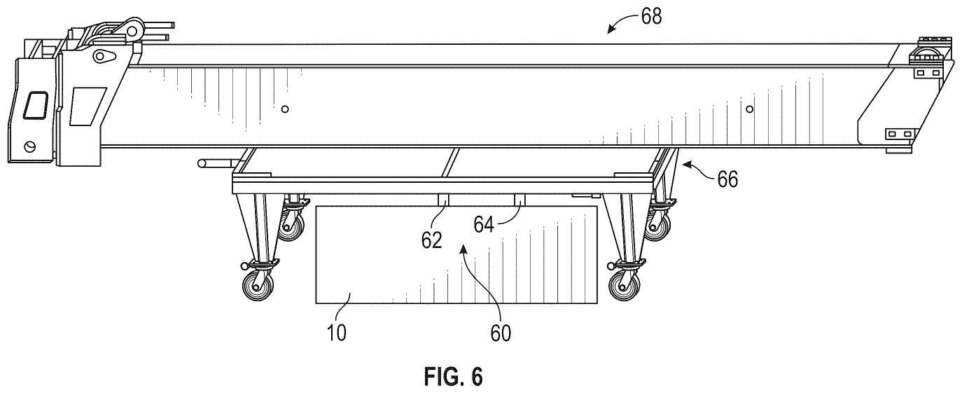

The frame 12, the drivetrain 40, and various other components coupled to the frame 12 form a base portion of the vehicle 10, shown as base assembly 48. To facilitate moving a product, the vehicle 10 may include an implement that that selectively couples the base assembly 48 to a product. FIGS. 3 and 4 illustrate a first implement, shown as lifting implement 50, and FIGS. 5 and 6 illustrate a second implement, shown as cart implement 60. Each implement may be received within the implement recess 20 and fixedly coupled to the frame 12. In some embodiments, the implement is removable from the implement recess 20 to facilitate interchanging with another type of implement. By way of example, the lifting implement 50 may be removed and replaced with the cart implement 60. In other embodiments, the implement is permanently installed on the vehicle.

Referring to FIGS. 3 and 4, the lifting implement 50 includes a product interface, shown as cradle 52, and a lift device or lifting assembly, shown as lift assembly 54. The cradle 52 is configured to receive and directly support a product, shown as telehandler 56. By way of example, the cradle 52 may receive an axle assembly of the telehandler 56. The lift assembly 54 couples the cradle 52 to the frame 12. The lift assembly 54 may be extended to raise the cradle 52 or retracted to lower the cradle 52. Accordingly, the lift assembly 54 may be used to raise or lower the telehandler 56.

Certain large products, such as the telehandler 56, may be difficult to support with only a single vehicle 10. To facilitate steering the product and spreading out the weight of the product, multiple vehicles 10 may be utilized. In the example shown in FIG. 4, a front axle of the telehandler 56 is supported by one vehicle 10, and a rear axle of the telehandler 56 is supported by another vehicle 10. In some embodiments, the vehicles 10 are independently operable. In other embodiments, operation of one vehicle 10 is dependent upon the other vehicle 10. By way of example, a first vehicle 10 may supply electrical energy to, propel, and/or control operation of the other vehicle 10.

Referring to FIGS. 5 and 6, the cart implement 60 includes a pair of protruding interface elements (e.g., pins), extending above the top surface 30. Specifically, the cart implement 60 includes a central pin, shown as driving pin 62, and an offset pin, shown as turning pin 64, that can each be selectively raised and lowered by an actuator of the cart implement 60. The driving pin 62 is centered about the central axis 46, and the turning pin 64 is offset from the central axis 46. The driving pin 62 and the turning pin 64 are positioned to a mobile platform, shown as cart 66, that supports a product subassembly, shown as boom assembly 68.

When extended, the driving pin 62 and the turning pin 64 each engage the cart 66 to limit movement of the cart 66 relative to the base assembly 48. When both the driving pin 62 and the turning pin 64 engage the cart 66, the cart 66 may be fixed to the base assembly 48. When only the driving pin 62 engages the cart 66, the base assembly 48 may rotate freely about the central axis 46 relative to the cart 66, but movement of the vehicle 10 in a particular direction may cause movement of the cart 66 in that same direction. When the driving pin 62 and the turning pin 64 are both retracted away from the cart 66, the vehicle 10 may move freely relative to the cart 66.

The cart 66 may be equipped with casters or slides to facilitate free movement of the cart 66 along the ground. In some embodiments, the cart 66 supports some or all of the weight of the boom assembly 68. The driving pin 62 and the turning pin 64 may generally push horizontally on the cart 66, such that there may be little or no transmission of vertical forces between the cart implement 60 and the cart 66. Accordingly, the vertical load on the vehicle 10 may be minimized while still permitting the vehicle 10 move the cart 66 and the boom assembly 68 throughout the environment as desired. This reduction in load may reduce the overall cost of the vehicle 10.

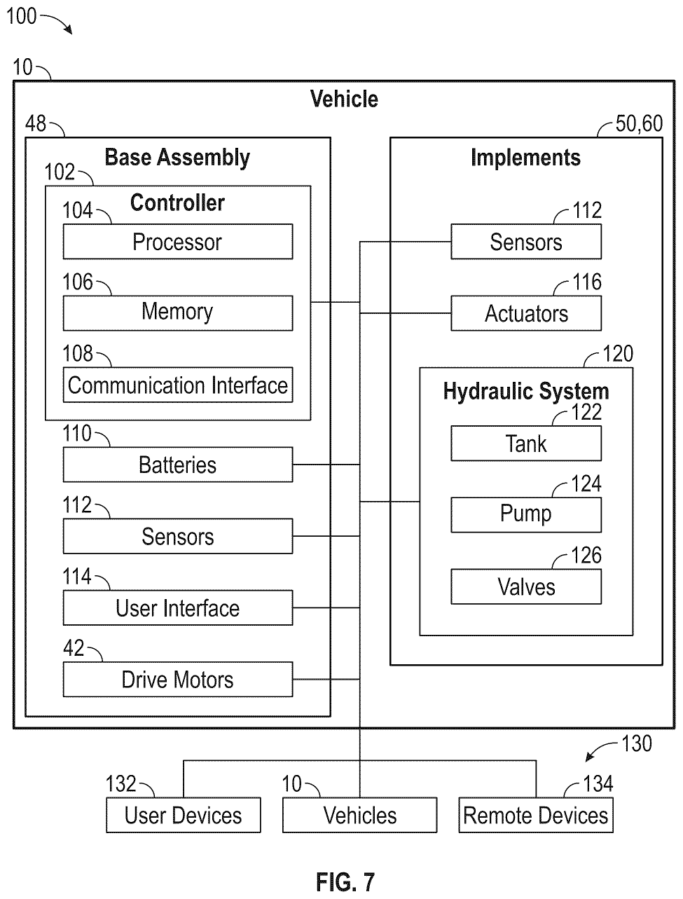

Referring to FIG. 7, the vehicle 10 and a control system 100 for the vehicle 10 are shown according to an exemplary embodiment. The control system 100 may facilitate operation of the vehicle 10 and/or other devices of a production environment. Although certain components are shown as being included in the base assembly 48 and/or the implements 50 and 60, it should be understood that any component may be positioned in the base assembly 48, the lifting implement 50, or the cart implement 60 or duplicated across multiple thereof.

The vehicle 10 includes a controller 102 that controls operation of the vehicle 10. The controller 102 includes a processing circuit, shown as processor 104, and a memory device, shown as memory 106. The memory 106 may contain one or more instruction that, when executed by the processor 104, cause the processor to perform the various functions described herein.

The controller 102 further includes a communication interface 108 (e.g., a communication circuit, a network interface, etc.) that facilitates communication with (e.g., to and from) other components of the vehicle 10 and/or the control system 100. The communication interface 108 may facilitate wired communication (e.g., through CAN, Ethernet, communication of power, etc.). Additionally or alternatively, the communication interface 108 may facilitate wireless communication (e.g., through Bluetooth, Wi-Fi, radio transmission, inductive transmission of energy, etc.).

The base assembly 48 includes one or more energy storage devices, shown as batteries 110. The batteries 110 store energy (e.g., as chemical energy). The batteries 110 may deliver electrical energy to other components of the vehicle 10 to power the vehicle 10. The batteries 110 may be charged by an outside source of energy (e.g., an electrical grid, a wireless charging interface, etc.). In other embodiments, the base assembly 48 includes a different type of energy storage device (e.g., a fuel tank for an internal combustion engine of a generator, a fuel cell, etc.).

The base assembly 48, the lifting implement 50, and the cart implement 60 may each include one or more sensors 112 operatively coupled to the controller 102. The sensors 112 may provide sensor data describing the current status of the vehicle 10 and/or the surrounding environment. By way of example, the sensors 112 may include mapping or imaging sensors (e.g., LIDAR sensors, light curtains, cameras, ultrasonic sensors, etc.). By way of example, the sensors 112 may include position sensors (e.g., GPS, potentiometers, encoders, etc.). By way of example, the sensors 112 may include orientation or acceleration sensors (e.g., accelerometers, gyroscopic sensors, inertial measurement units, compasses, etc.). By way of example, the sensors 112 may include pressure sensors, flowmeters, buttons, or other types of sensors.

The base assembly 48 may include one or more operator interface elements (e.g., input devices, output devices, etc.), shown as user interface 114. The user interface 114 may include output devices that provide information to one or more users. By way of example, the user interface 114 may include displays, speakers, lights, haptic feedback (e.g., vibrators, etc.), or other output devices. The user interface 114 may include input devices that receive information (e.g., commands) from one or more users. By way of example, the user interface 114 may include buttons, switches, knobs, touchscreens, microphones, or other input devices.

The lifting implement 50 and/or the cart implement 60 may include one or more actuators 116 that facilitate controlled movement (e.g., movement of the lifting implement 50 or the cart implement 60). The actuators 116 may include linear actuators (e.g., electric linear actuators, hydraulic cylinders, etc.), motors (e.g., electric motors, hydraulic motors, etc.), or other types of actuators. The actuators 116 may be electrically-powered, hydraulically-powered, or otherwise powered.

The lifting implement 50 and/or the cart implement 60 may include a hydraulic system 120. They hydraulic system 120 may supply pressurized hydraulic fluid (e.g., hydraulic oil) to facilitate operation of other components of the vehicle 10. By way of example, the hydraulic system 120 may supply pressurized hydraulic fluid to an actuator 116. In some embodiments, the hydraulic system 120 forms a self-contained hydraulic loop with one or more actuators 116.

The hydraulic system 120 includes a low-pressure reservoir, shown as tank 122, that stores a volume of hydraulic fluid at a low pressure. A pump 124 receives electrical energy from the batteries 110, draws hydraulic fluid from the tank 122, and supplies a flow of pressurized hydraulic fluid. One or more valves 126 (e.g., solenoid valves, directional control valves, etc.) control the flow of the hydraulic fluid from the pump 124. By way of example, the valves 126 may control the flow rate, direction, and destination of hydraulic fluid flowing throughout the hydraulic system 120. The controller 102 may control operation of the actuators 116 by controlling the valves 126.

The control system 100 further includes additional devices in communication with the vehicle 10. The devices may communicate with the vehicle 10 directly or through a network 130 (e.g., a local area network, a wide area network, the Internet, etc.). The network 130 may utilize wireless and/or wired communication. In some embodiments, the network 130 is a mesh network formed between multiple devices of the control system 100 (e.g., permitting indirect communication between two devices through a third device).

The control system 100 may include multiple vehicles 10. A vehicle 10 may communicate with other vehicles 10 to share information and facilitate operation. By way of example, a vehicle 10 may provide commands to another vehicle 10 to coordinate transportation of a large item that is carried by both of the vehicles 10. By way of another example, a vehicle 10 may provide its location to another vehicle 10 to facilitate path generation and avoid collisions.

The control system 100 may include one or more user devices 132 (e.g., smartphones, tablets, laptops, desktop computers, etc.). The user devices 132 may facilitate a user monitoring and/or controlling operation of the vehicles 10. By way of example, the user devices 132 may indicate statuses of the vehicles 10 (e.g., positions, whether maintenance is needed, if any errors are occurring, what task a vehicle 10 is assigned, etc.). By way of example, the user devices 132 may permit a user to command a vehicle 10 to travel to a different place or to assign a vehicle 10 to a particular production line.

The control system may include one or more remote devices 134 (e.g., servers). In some embodiments, a remote device 134 functions as a production manager that controls various operations throughout a manufacturing environment. The production manager may receive requests for production of certain equipment (e.g., fifteen telehandlers are requested for production by Apr. 12, 2025, etc.). The production manager may monitor the statuses of vehicles 10, personnel, equipment, and raw materials. By way of example, the vehicles 10 may provide sensor data from the sensors 112 to a remote device 134 for storage and/or analysis. Based on the available data, the production manager may generate assignments for vehicles 10, personnel, equipment, and raw materials to meet the production requests. The production manager may adapt to changes in availability (e.g., by reassigning a vehicle 10 to a different task or area in response to a failure of one of the vehicles 10). The assignments for a vehicle 10 may include a path along which the vehicle 10 should travel, a desired configuration of the vehicle 10 (e.g., the type of implement available to the vehicle 10), an amount of time that the vehicle 10 should wait at a given station, etc.

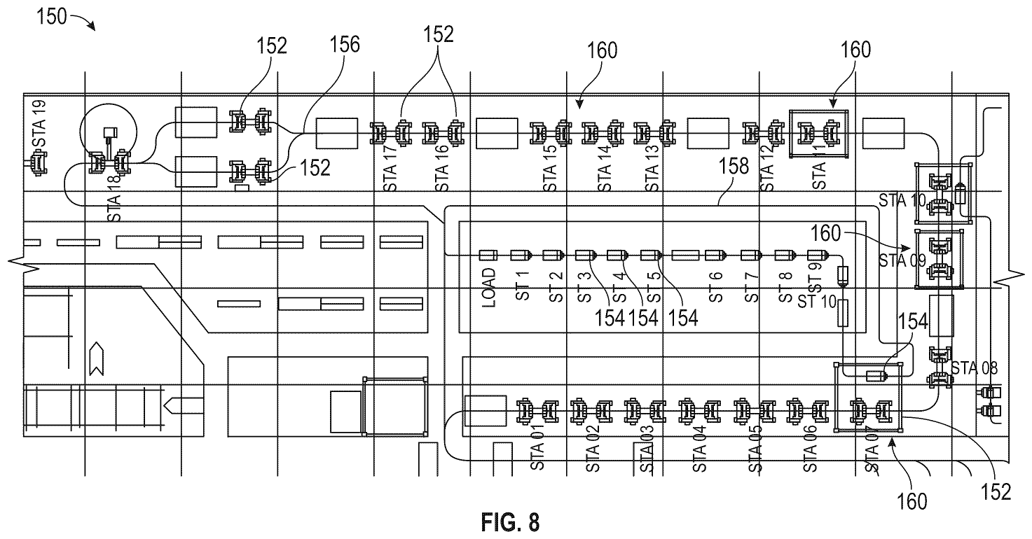

Referring to FIG. 8, a manufacturing environment or production system 150 is shown according to an exemplary embodiment. The production system 150 may include a series of vehicles 10 that move a product 152 and a subassembly 154 through various stages of assembly (e.g., as controlled by a remote device 134). The vehicles 10 move the product 152 along a first path, shown as manufacturing line 156, and the vehicles 10 move the subassembly 154 along a second path, shown as manufacturing line 158. A series of manufacturing or assembly stations, shown as stations 160, are spaced at regular intervals along the manufacturing lines 156 and 158. Each station 160 may be associated with a different manufacturing or assembly process that is performed there. By way of example, there may be stations 160 for attaching components to a product 152, coupling components with hoses or wires, confirming that certain functions are operating properly, etc.

Initially the product 152 and the subassembly 154 move along separate manufacturing lines 156 and 158. After the last station 160 needed to prepare the subassembly 154, the manufacturing line 158 intersects the manufacturing line 156, and the subassembly 154 is attached to the product 152. The product 152 and the subassembly 154 then move together along the manufacturing line 156. This proceeds until the product 152 is fully assembled and removed from the vehicles 10. The vehicles 10 may then return to collect another product that requires assembly, and the manufacturing process is repeated.

In some embodiments, the product 152 assembled by the production system is a vehicle or work machine. By way of example, the product 152 may be a lift device, such as a telehandler, a scissor lift, a boom lift, a vertical lift, an aerial work platform, or another type of lift device. By way of another example, the product 152 may be a fire truck, an aircraft rescue and firefighting apparatus (ARFF) truck, a refuse vehicle, a concrete mixing truck, a tow truck, a broadcast van, a military vehicle, a robot, a truck, a van, a passenger vehicle, or another type of vehicle. In other embodiments, the product 152 is not a vehicle (e.g., is a stationary piece of equipment).

### Reconfiguration of Vehicle Operation and Corresponding Autonomous Modes

As described above, one or more of the vehicles 10 (e.g., one or more embodiments of the vehicle 10 shown in, and described with reference to, FIG. 1) may be configured to operate in a plurality of different modes of operation, including different degrees of autonomous operation (e.g., manually controlled, partially autonomous, or fully autonomous). In some embodiments, a vehicle 10 is configured to switch between different modes of operation (e.g., between a mode of operation that is substantially user controlled to a mode of operation that is fully, or at least substantially, autonomous). Stated, differently, in some embodiments, the vehicles 10 are configured to switch between different levels of autonomous operation (e.g., minimally autonomous to fully autonomous and vice versa) based on information related to the operation of the one or more vehicles 10 and/or the environment surrounding the vehicles 10, including based on the feasibility of operating a vehicle 10 autonomously in the presence of one or more different operational conditions (e.g., inclement weather, power outage, steep grades, spills, unexpected obstacles, etc.). For example, the vehicles may switch between a first mode of operation and a second mode of operation based on a match value determined from sensor data, which is indicative of one or more operational conditions, and one or more operational criteria.

The vehicles 10 switch between a first mode of operation and a second mode of operation based on sensor data indicative of one or more operational conditions and one or more operational criteria. More specifically, the vehicle may determine a mode of operation based on sensor data relevant to the operation of the vehicle 10 and/or the environment surrounding the vehicle 10, including, for example, data collected by one or more sensors (e.g., sensors 112), light sensors, traction data (e.g., sensor data indicating a quality of the terrain on which the vehicle operates), load data (sensor data indicative of a load position, load orientation, the distribution of a load including between two or more vehicles, etc.), location data, network data, energy supply and state data (e.g., of batteries 110, etc.) such as a state of charge, and the like. The sensor data may be provided by sensors 112 of the vehicle 10, or based on sensor data provided by one or more remote device 134 or other vehicles 10 communicably coupled to the vehicle 10.

For example, a vehicle 10 may initially operate in a first mode or as an autonomous mobile robot and receive sensor data from one or more sensors 112 (e.g., cameras, LIDAR, etc.) indicative of a large unexpected obstacle in the vehicle's path. The vehicle 10 may initially remain in the first mode, and continue to operate as an autonomous mobile robot and upon unsuccessfully attempting to navigate around the unexpected obstacle, or due to sensor data indicating one or more additional operational conditions (e.g., low light/visibility, unexpected location, and/or an unstable load carried by the vehicle), the vehicle 10 may change operation to operate in a second mode (e.g., as an autonomous guided vehicle or a semi-autonomous guided vehicle, as described above). In some embodiments, the vehicle 10 may operate in one of a plurality of modes such as an autonomous mode, a semi-autonomous mode, or a manual mode and transition to a different mode of the plurality of modes based a command from at least one of a user device (e.g., user device 132), user interface 114, or remote device 134.

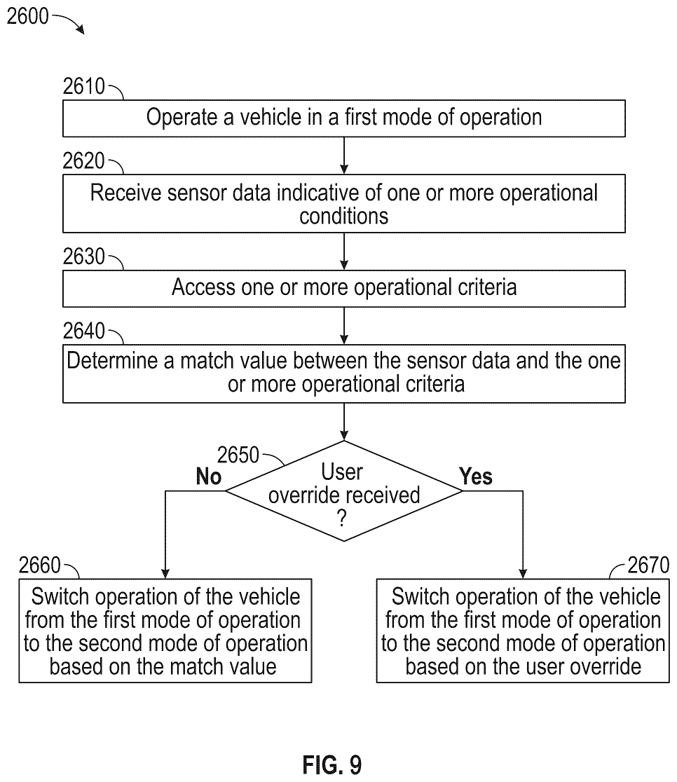

FIG. 9 depicts an example method for adjusting the mode of operation of a vehicle, according to one embodiment of the present disclosure. The method 2600 can be performed by at least the controller 102 and/or processor 104 of the system 100 depicted in FIG. 7, but is not limited thereto. In some implementations, one or more of the steps may be performed by a different processor, server, or any other computing device (e.g., user devices 132 and/or remote devices 134 of FIG. 7). For instance, one or more of the steps may be performed via a cloud-based service including any number of servers, which may be in communication with a processor of the vehicle 10 and/or an associated control system.

Although the steps are shown in FIG. 9 having a particular order, the steps may be performed in any order. In some instances, some of these steps may be optional. The method 2600 may be executed to improve the operation of one or more vehicles, including vehicles operating autonomously, and/or semi autonomously, within a manufacturing environment.

The method 2600 can, in some embodiments, include a method of operating a vehicle. In some embodiments, the method 2600 can include operating 2610 a vehicle in a first mode of operation. The vehicle 10 may include a plurality of modes of operation such as an autonomous mode, a semi-autonomous mode, and a user-guided or manual mode. In the autonomous mode, the vehicle 10 may be referred to as a self-guided vehicle or an autonomous mobile robot (AMR). In the semi-autonomous mode, the vehicle may be referred to as an automated guided vehicle (AGV). In the user-guided mode, the vehicle may be a remote-controlled vehicle. For example, in some embodiments, the method 2600 may include operating a vehicle in a first mode of operation that is fully autonomous or as an automated mobile robot, as described above, with reference to FIGS. 1 and 2. The autonomous mobile robot may be configured to operate within a manufacturing environment, including to move one or more components and/or products, without, or substantially without, user intervention or direct input from a user to control the operation of the vehicle 10.

Alternatively, or in addition, the vehicle 10 may operate in a first mode of operation that is substantially user controlled and/or that requires substantial input from a user to operate the vehicle 10, such as to steer the vehicle 10 while it is in a semi-automated guided vehicle configuration. For example, the vehicle 10 may operate in a semi-autonomous guided vehicle configuration based on the presence of one or more operating conditions.

The method 2600 can further include receiving 2620 sensor data indicative of one or more operational conditions. In some embodiments, operational conditions may include one or more conditions of the vehicles' environment that relate to the vehicle's operation. Operational conditions may include, for example, local weather, vehicle location, grade, traction, connectivity, proximity to one or more additional vehicles, tire pressure, battery levels, detected obstacles and/or obstructions, load data, light and/or visibility, sound, temperature, etc. The sensor data may be provided by the sensors 112 of the vehicle 10 or received from one or more other vehicles 10.

For example, in some embodiments, the method 2600 can receive sensor data indicative of an exceptionally steep grade based on or more orientation sensors of the vehicle 10 and may further receive sensor data indicative of a low traction environment (e.g., as traction data based on, or received from, the operation of the vehicle's drivetrain).

The method 2600 can include accessing 2630 one or more operational criteria, wherein the one or more operational criteria correspond to one or more operational modes of the vehicle. The operational criteria may include one or more criteria specified for one or more different modes of operation of the vehicle, including, for example, one or more criteria that prohibit, or substantially conflict with, one or more modes of operation of the vehicle 10. For example, the operational criteria may include criteria that specify the vehicle 10 operate in a user controlled mode when a grade is above a given angle, when vehicle traction is inconsistent, or when the vehicle's load is precarious and/or difficult to maneuver safely.

Alternatively, or in addition, the one or more operational criteria may specify that a semi-autonomous and/or partially autonomous operation of the vehicle 10 may be used in the presence of certain operational conditions. For example, where the vehicle 10 has reliable connectivity to a vehicle network and/or guiding features, the vehicle may continue to operate autonomously even when a load is large, heavy, and/or costly, or the vehicle must maneuver between relatively small spaces and/or with little physical clearance.

In some embodiments, the method 2600 can include determining 2640 a match value between the sensor data (e.g., received at 2620) and the one or more operational criteria (e.g., accessed at 2630). For example, the method 2600 can include determining a match value via the controller 102 and/or the processor 104 of the vehicle. In some embodiments, determining the match value may include determining a degree of overlap and/or similarity between the operational conditions indicated by the sensor data and the one or more operational criteria accessed at 2630. For example, the method 2600 can include determining a match value for each operational condition for which sensor data has been received and for which an operational criteria may apply.

In some embodiments, the method 2600 can include determining if a user override is received at 2650. The user override can be a user input designating a mode of operation for the vehicle to operate in. For example, the user override can indicate the vehicle 10 should change from a manual mode to an autonomous mode.

In some embodiments, if a user override is not received, the method 2600 can include switching 2660 operation of the vehicle 10 from the first mode of operation to a second mode of operation based on the match value indicating a match between one or more operational criteria and the one or more operational conditions indicated by the sensor data. For example, the vehicle 10 controller 102 may change the operation of the vehicle from fully autonomous, or autonomous mobile robot operation, to a second mode of operation as a semi-autonomous guided vehicle for which steering must be controlled via user input. The vehicle may change to a SGV mode of operation based on the match value indicating the vehicle 10 lacks network connectivity and is located in an unexpected location (e.g., outside of an expected manufacturing environment and/or manufacturing station).

In some embodiments, if a user override is received at 2650, the method 2600 can include switching 2670 operation of the vehicle 10 from the first mode of operation to a second mode of operation based on the user override. For example, a user can override the vehicle and inhibit it from transitioning to an autonomous mode, and instead direct it to a manual mode. The user override otherwise direct the vehicle 10 to transition to any of the modes.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the production system as shown in the various exemplary embodiments is illustrative only. Additionally, any element disclosed in one embodiment may be incorporated or utilized with any other embodiment disclosed herein. For example, the vehicle of the exemplary embodiment shown in at least FIGS. 1 and 2 may be incorporated in the exemplary embodiment shown in at least FIGS. 3 and 4. As another example, the vehicle 10 of the exemplary embodiment shown in at least FIG. 1 may be incorporated into, or used to perform, the method 2600 and/or any portion thereof. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A vehicle comprising:
a frame;
a drive system coupled to the frame and configured to propel and steer the vehicle;
an energy storage device coupled to the frame and configured to provide power to the drive system;
a lift implement coupled to the frame, the lift implement comprising a cradle to support a load and a lift assembly configured to adjust a position of the cradle relative to the frame;
one or more sensors configured to provide sensing data indicative of at least one of a status of the vehicle, the load supported by the cradle, or an environment surrounding the vehicle; and
a controller comprising one or more memory devices having instructions stored thereon, that, when executed by one or more processors, cause the one or more processors to:
operate the vehicle in a first mode of a plurality of modes, wherein the plurality of modes comprises a manual mode, a guided vehicle mode, and an autonomous mode;
determine a match value between the sensing data and at least one operational criteria of a plurality of operational criteria; and
operate the vehicle in a second mode of the plurality of modes based on the match value, wherein the second mode is different than the first mode.

2. The vehicle of claim 1, wherein the sensing data is indicative of the status of the vehicle, and wherein the status comprises at least one of:
a network connectivity status;
a level of traction;
a tire pressure level;
a status of the energy storage device; or
an obstacle within a path of the vehicle.

3. The vehicle of claim 1, wherein the sensing data is indicative of the load supported by the cradle, and comprises at least one of:
a weight of the load;
a length of the load;
an orientation of the load; and
whether the load is shared with a second vehicle.

4. The vehicle of claim 1, wherein the sensing data is indicative of the environment surrounding the vehicle, and comprises at least one of:
a light level;
a visibility level;
local weather in the environment surrounding the vehicle;
a grade; or
a temperature.

5. The vehicle of claim 1, wherein the first mode is an autonomous mode.

6. The vehicle of claim 1, wherein the first mode is a manual mode.

7. The vehicle of claim 1, wherein the one or more sensors comprises a first sensor positioned on the vehicle and a second sensor off-board of the vehicle.

8. The vehicle of claim 1, wherein in the guided vehicle mode the vehicle autonomously traverses a predefined route.

9. The vehicle of claim 8, wherein the predefined route is a fixed navigational element positioned in the environment surrounding the vehicle and sensed by the one or more sensors.

10. A method of operating a vehicle, comprising:
operating, by one or more processing circuits, a vehicle in a first mode of a plurality of modes, wherein the plurality of modes comprises a manual mode, a guided vehicle mode, and an autonomous mode;
receiving, by the one or more processing circuits, sensor data indicative of one or more operational conditions;
determining, by the one or more processing circuits, a match value between the one or more operational conditions indicated by the sensor data and one or more operational criteria, wherein the one or more operational criteria correspond to a mode of the plurality of modes and one or more operational conditions; and
switching, by the one or more processing circuits, operation of the vehicle from the first mode to a second mode of the plurality of modes different than the first mode based on the match value indicating a match between one or more operational criteria and the one or more operational conditions indicated by the sensor data.

11. The method of claim 10, wherein the vehicle comprises a cradle configured to support a load.

12. The method of claim 11, wherein the one or more operational conditions comprise at least one of a weight of the load, an orientation of the load, or a size of the load.

13. The method of claim 10, wherein the first mode the autonomous mode.

14. The method of claim 10, wherein the first mode is the manual mode.

15. The method of claim 10, wherein the first mode is the guided vehicle mode.

16. The method of claim 10, wherein receiving the sensor data comprises receiving the sensor data from one or more sensors external to the vehicle.

17. The method of claim 10, further comprising:
receiving, by the one or more processing circuits, a override request from a user; and
switching, by the one or more processing circuits, operation of the vehicle to a third mode of the plurality of modes, wherein the third mode is different than the first mode, based on the override request.

18. A method of operating a vehicle, comprising:
operating, by one or more processing circuits, a vehicle in a first mode of a plurality of modes, wherein the plurality of modes comprises a manual mode, a guided vehicle mode, and an autonomous mode, the vehicle comprising:
a frame;
a drive system coupled to the frame and configured to propel and steer the vehicle;
an energy storage device coupled to the frame and configured to provide power to the drive system;
a lift implement coupled to the frame, the lift implement comprising a cradle to support a load and a lift assembly configured to adjust a position of the cradle relative to the frame; and
one or more sensors configured to provide sensing data indicative of at least one of a status of the vehicle, the load supported by the cradle, or an environment surrounding the vehicle;
receiving, by the one or more processing circuits, sensor data from the one or more sensors indicative of one or more operational conditions;
determining, by the one or more processing circuits, a match value between the one or more operational conditions indicated by the sensor data and one or more operational criteria, wherein the one or more operational criteria correspond to a mode of the plurality of modes and one or more operational conditions; and
switching, by the one or more processing circuits, operation of the vehicle from the first mode to a second mode of the plurality of modes different than the first mode based on the match value indicating a match between one or more operational criteria and the one or more operational conditions indicated by the sensor data.

19. The method of claim 18, wherein the one or more operational conditions comprise at least one of a weight of the load, an orientation of the load, or a size of the load.

20. The method of claim 18, wherein the one or more sensors comprises a first sensor positioned on the vehicle and a second sensor off-board of the vehicle.
